(19) United States
(12) Patent Application Publication
(10) Pub. No.: US 2020/0063772 A1
(43) Pub. Date: Feb. 27, 2020

(54) CONNECTION FASTENER, CONNECTION ASSEMBLY AND CONNECTION MECHANISM USING SAME

(71) Applicant: Wei Lin, Auckland (NZ)

(72) Inventor: Wei Lin, Auckland (NZ)

(21) Appl. No.: 16/537,662

(22) Filed: Aug. 12, 2019

Related U.S. Application Data
(63) Continuation of application No. PCT/CN2018/074699, filed on Jan. 31, 2018.

(30) Foreign Application Priority Data
Feb. 15, 2017 (CN) 201710080660.9

(51) Int. Cl. F16B 5/02; E04B 1/41

(52) U.S. Cl. CPC F16B 5/02; E04B 1/40

(57) ABSTRACT

Disclosed are a connection fastener, a connection assembly and a connection structure using the same. By arranging an adjustment component with a first gear and at least one follow-up component with a second gear, the rotation of the first gear of the adjustment component drives the second gear connected therewith to rotate, and then a fastening part of the follow-up component rotates with the second gear, and a circumferential rotation force applied to the fastening part by the gears is converted into an axial force of the fastening part through threads, so as to tighten and fix two or more structural members at an arbitrary angle, thereby achieving a simple, fast and stable connection for a complex structure.

### CROSS REFERENCE TO RELATED APPLICATION

The present application claims the priority of the Chinese application No. 201710080660.9 with the title of “CONNECTION FASTENER, CONNECTION ASSEMBLY AND CONNECTION STRUCTURE USING THE SAME” filed on Feb. 15, 2017, the entire contents of which is incorporated herein by reference.

### FIELD OF THE INVENTION

The present disclosure relates to the field of mechanical installation and building installation, in particular to a connection fastener, a connection assembly and a connection structure using the same

### BACKGROUND

In various existing products or buildings, structural members are usually connected by using angle iron in combination with expansion screw or self-tapping screw in the case that adhesive or welding is not used. The structural members connected in this way are easy to loosen and fall off or the threads of the structural members are prone to be damaged in use or during the course of multiple reorganizations, which makes the connection structure unstable with a poor durability. At the meanwhile, it is hard to connect and fasten the plates which need to form a predetermined angle therebetween or have special shapes.

### SUMMARY

In view of this, the present disclosure provides a connection fastener, a connection assembly and a connection structure using the same to achieve a simple, fast and stable connection for multiple structural members.

According to a first aspect of the present disclosure, a connection fastener is provided for connecting a plurality of structural members, the connection fastener includes:

an adjustment component with a main part and a first gear suitable for rotating with the main part;

at least one follow-up component, each of which has a second gear connected with the first gear and a fastening part suitable for rotating with the second gear;

a base provided with a hollow accommodation part to accommodate the first gear of the adjustment component and the second gears of all the follow-up components, wherein the base is also provided with multiple holes through which the fastening parts of the follow-up components are exposed or protruded; and

connection components corresponding to the follow-up components one by one, each of the connection components connected with a respective fastening part of the follow-up component in a separable manner,

wherein the connection component has a connection sheet suitable for connecting with a corresponding structural member and suitable for moving in axial direction of the fastening part with the rotation of the fastening part.

In one embodiment, the connection component further includes:

a screw rod fixedly connected with the connection sheet in a non-relative rotation manner,

wherein the fastening part is formed into a cylindrical shape with a screw hole in the middle thereof, and the screw hole of the fastening part and the screw rod cooperate with each other.

In one embodiment, the connection sheet is provided with a hole, and

the connection component further includes:

a screw suitable for protruding through the hole of the connection sheet,

wherein the fastening part is formed into a cylindrical shape with a screw hole in the middle thereof, and the screw hole of the fastening part and the screw cooperate with each other.

In one embodiment, the fastening part of the follow-up component is a screw rod with one end connected with the second gear, and

the connection sheet is provided with a screw hole arranged to cooperate with the screw rod.

In one embodiment, the follow-up component is rotatably arranged in the base.

In one embodiment, the first gear and the second gear are bevel gears that cooperate with each other.

In one embodiment, the connection fastener has one follow-up component, and

the base is provided with a fixed hole for fixing the base with the corresponding structural member.

In one embodiment, the connection fastener has two follow-up components, the end faces of the second gears of the two follow-up components are close to each other, and the axes of the second gears form a predetermined included angle, and

the adjustment component is arranged in such a way that the first gear is positioned between the second gears of the two follow-up components.

In one embodiment, the predetermined included angle is the same as the included angle between the structural members to be connected and is greater than or equal to 90 degrees and less than or equal to 180 degrees.

In one embodiment, the connection fastener has a plurality of follow-up components which are arranged so that the end faces of corresponding second gears are close to each other and the axes of the second gears are coplanar, and

the adjustment component is arranged so that the first gear is coupled with the second gears of the plurality of follow-up components at the same time.

In one embodiment, the base is provided with a fixed hole for fixing the base with the corresponding structural member.

According to a second aspect of the present disclosure, a connection assembly is provided which includes:

an adjustment component with a main part and a first gear suitable for rotating with the main part;

at least one follow-up component, each of which has a second gear connected with the first gear and a fastening part suitable for rotating with the second gear; and

a base provided with a hollow accommodation part to accommodate the first gear of the adjustment component and the second gears of all the follow-up components, wherein the base is also provided with multiple holes through which the fastening parts of the follow-up components are exposed or protruded.

In one embodiment, the fastening part is formed into a cylindrical shape with a screw hole in the middle thereof.

In one embodiment, the fastening part is a screw rod with one end connected with the second gear.

In one embodiment, the follow-up component is rotatably arranged in the base.

In one embodiment, the first gear and the second gear are bevel gears that cooperate with each other.

In one embodiment, the connection assembly has one follow-up component, and

the base is provided with a fixed hole for fixing the base with the corresponding structural member.

In one embodiment, the connection assembly has two follow-up components which are arranged so that the end faces of corresponding second gears are close to each other, and the axes of the second gears form a predetermined included angle, and

the adjustment component is arranged in such a way that the first gear is positioned between the second gears of the two follow-up components.

In one embodiment, the predetermined included angle is the same as the included angle between the structural members to be connected and is greater than or equal to 90 degrees and less than or equal to 180 degrees.

In one embodiment, the connection assembly has a plurality of follow-up components which are arranged so that the end faces of the second gears thereof are close to each other and the axes of all the second gears are coplanar, and

the adjustment component is arranged so that the first gear is coupled with the second gears of all the follow-up components at the same time.

In one embodiment, the base is provided with a fixed hole for fixing the base with the corresponding structural member.

According to a third aspect of the present disclosure, a connection structure is provided which includes:

a plurality of structural members; and

the connection fastener as mentioned above for connecting the plurality of structural members with each other.

According to the present disclosure, by arranging an adjustment component with a first gear and at least one follow-up component with a second gear, the rotation of the first gear of the adjustment component drives the second gear connected therewith to rotate, and then a fastening part of the follow-up component rotates with the second gear, and a circumferential rotation force applied to the fastening part by the gears is converted into an axial force of the fastening part through the threads, so as to tighten and fix two or more structural members at an arbitrary angle, thereby achieving a simple, fast and stable connection for multiple structural members.

### BRIEF DESCRIPTION OF THE DRAWINGS

The above and other objects, features and advantages of the present disclosure will become more apparent from the following description of the embodiments of the present disclosure with reference to the accompanying drawings in which:

FIG. 1 is a stereoscopic schematic diagram of a connection structure according to a first embodiment of the present disclosure.

FIG. 2 is a stereoscopic schematic diagram of the connection structure according to the first embodiment of the present disclosure with the base being separated.

FIG. 3 is a top view of the connection structure according to the first embodiment of the present disclosure.

FIG. 4 is a side view of the connection structure according to the first embodiment of the present disclosure with the base being separated.

FIG. 5 is a stereoscopic schematic diagram of an adjustment component according to the first embodiment of the present disclosure.

FIG. 6 is a stereoscopic schematic diagram of a fastening part and a connection component in a connection state according to the first embodiment of the present disclosure.

FIG. 7 is a cross-sectional view of a fastening part and a connection component in a connection state according to the first embodiment of the present disclosure.

FIG. 8 is a stereoscopic schematic diagram of a connection sheet according to the first embodiment of the present disclosure.

FIG. 9 is a stereoscopic schematic diagram of a connection structure according to a second embodiment of the present disclosure.

FIG. 10 is a stereoscopic schematic diagram of the connection structure according to the second embodiment of the present disclosure with the base being separated.

FIG. 11 is a stereoscopic schematic diagram of a connection structure according to a third embodiment of the present disclosure.

FIG. 12 is a stereoscopic schematic diagram of the connection structure according to the third embodiment of the present disclosure with the base being separated.

FIG. 13 is a side view of the connection structure according to the third embodiment of the present disclosure with the base being separated.

FIG. 14 is a stereoscopic schematic diagram of a connection structure according to a fourth embodiment of the present disclosure.

FIG. 15 is a side view of the connection structure according to the fourth embodiment of the present disclosure.

FIG. 16 is a stereoscopic schematic diagram of a follow-up component according to the fourth embodiment of the present disclosure.

FIG. 17 is a stereoscopic schematic diagram of a connection sheet according to the fourth embodiment of the present disclosure.

FIG. 18 is a stereoscopic schematic diagram of a connection structure according to a fifth embodiment of the present disclosure.

FIG. 19 is a stereoscopic schematic diagram of a connection structure according to the fifth embodiment of the present disclosure.

### DETAILED DESCRIPTION

The present disclosure will be described below with reference to the following embodiments, but the present disclosure is not limited to these embodiments. Some specific details are described in detail in the following detailed description of the present disclosure. The present disclosure can be understood by those skilled in the art without those descriptions of the details. In order to avoid obscuring the essence of the disclosure, well-known methods, processes, procedures, components and circuits are not described in detail.

In addition, it will be understood by those skilled in the art that the drawings provided herein are for illustrative purpose and are not necessarily drawn to scale.

Unless the context clearly requires otherwise, the words “comprising”, “including” and the like in the entire specification and claims should be construed as the meaning of inclusion rather than the meaning of exclusion or exhaustion, that is, the meaning of “including but not limited to”.

In the description of the present disclosure, it needs to be understood that the terms “first”, “second” and the like are for illustrative purposes only and should not to be construed as indicating or implying relative importance. In addition, in the description of the present disclosure, the meaning of “a plurality of” means two or more, unless otherwise specified.

Unless otherwise expressly specified or defined, terms “mount”, “couple”, “connect” and “fix” should be understood broadly, and for example, a connection may be a fixed connection, or a detachable connection, or an integrated connection; a connection may be a mechanical connection or an electric connection; a connection may be a direct connection, or an indirect connection via an intermediate medium, or may be an internal communication between two elements or an interaction between two elements, Unless otherwise expressly specified. The specific meanings of the above-mentioned terms as used herein could be understood by those skilled in the art according to specific situations.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on”, “directly engaged to”, “directly connected to” or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. It will be understood that spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

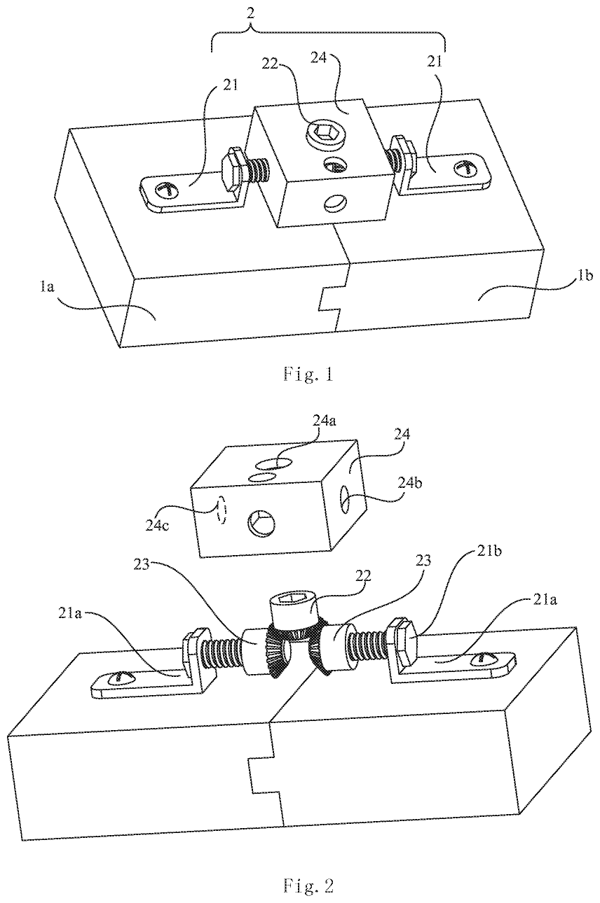

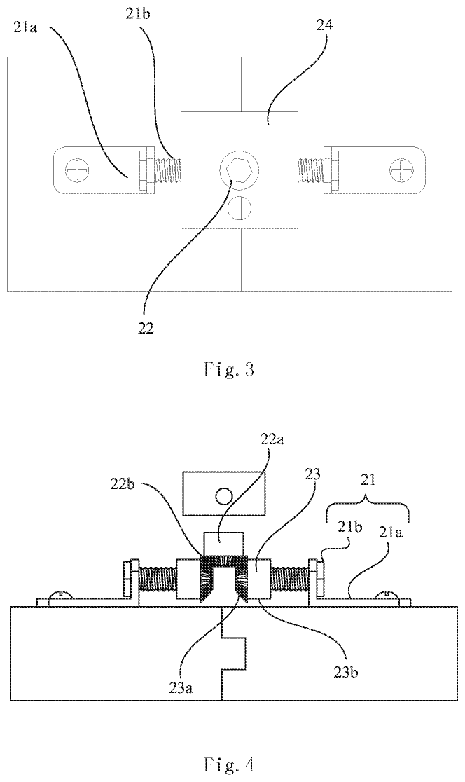

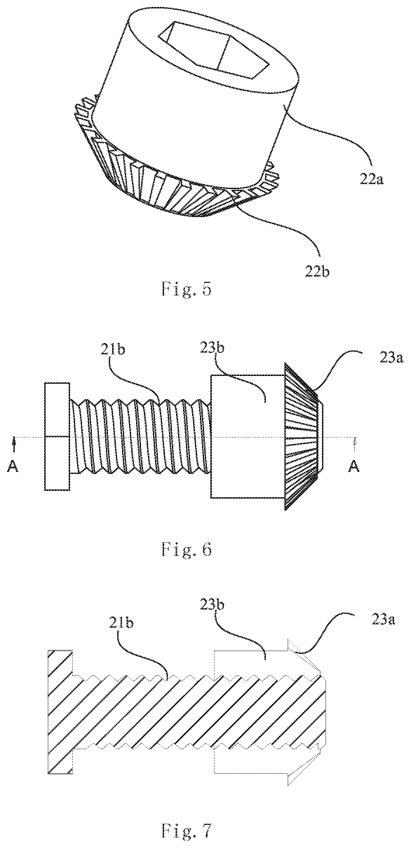

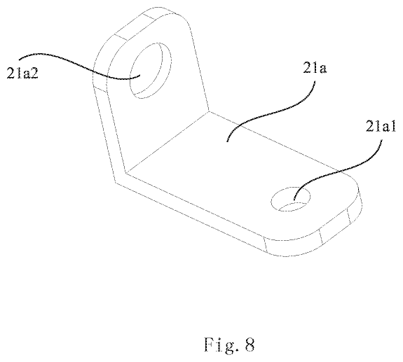

The connection structure and the connection fastener according to the first embodiment of the present disclosure are shown in FIGS. 1-8, in which the connection structure according to the present embodiment includes two flat structural members 1a and 1b and a connection fastener 2 for connecting and fastening them together.

In the present embodiment, the structural member may be a structural member used to construct a building structure, for example, a wall panel of a light building. However, the structural member of the present embodiment is not limited to a structural member with a flat plate shape. Any structural member that can be connected and fastened by two opposing forces with an included angle of 180 degrees can be applied to the present embodiment. Of course, it can be easily understood by those skilled in the art that the connection fastener 2 according to the present embodiment is also suitable for connecting any other structural members that need to be combined with each other through a joint surface to form different connection structures.

The connection fastener 2 includes a connection assembly and connection components 21. Two connection components 21 correspond to and are fixed on structural embers la and 1b to be connected respectively. The connection assembly is arranged in a manner that it can be separated from the connection components 21 and includes an adjustment component 22, two follow-up components 23 and a base 24. The adjustment component 22 has a main part 22a and a gear 22b suitable for rotating with the main part. In the present embodiment, the gear 22b is formed as a bevel gear. Meanwhile, the main part 22a is formed into be substantially coaxial with the bevel gear with one end connected with an end face of the gear 22b. At the meanwhile, the main part 22a can be provided with a hexagonal slot at the end distant from the gear 22b for an inner hexagonal wrench to drive the main part 22a to rotate. Thus, when the main part 22a is driven to rotate, the gear 22b rotates as well. It should be understood that the hexagonal slot can be replaced by slots with other shapes or by a single slot or a cruciate slot that can be rotated by a screwdriver. The end of the main part 22a can also be formed into a hexagonal shape or other shapes so that the main part 22a can be driven to rotate by an outer hexagonal wrench or other corresponding tools.

The follow-up component 23 has a gear 23a and a fastening part 23b suitable for rotating with the gear 23a. The gear 23a is arranged to cooperate with the gear 22b. The follow-up components 23 and the adjustment component 22 are fixed within the base 24 in a rotatable way so that the gears 23a of all the follow-up components 23 are connected with the gear 22b. The base 24 is provided with a hollow accommodation part to accommodate the gear 22b of the adjustment component and the gears 23a of the two follow-up components. In the present embodiment, the gear 23a is arranged to be a bevel gear that cooperates with the gear 22b. The gear 22b is horizontally arranged with its axis substantially perpendicular to the plane of the structural members that are connected. The gear 23a is vertically arranged with its axis substantially parallel to the plane of the structural members that are connected. The two follow-up components 23 are arranged opposite to each other with the gears 23a facing each other and connected with the gears 22b on their sides.

At the meanwhile, the base 24 is provided with a hole 24a on its top so that the main part 22a of the adjustment component 22 can be exposed or protruded through the hole 24a. The base 24 is provided with holes 24b and 24c on two opposite sides so that the fastening parts 23b of the two follow-up components 23 can be exposed through the holes 24b, 24c.

In the present embodiment, the fastening part 23b of the follow-up component 23 is formed to a cylindrical shape with a screw hole in the middle thereof. One end of the fastening part 23b is connected with the end face of the gear 23a and the fastening part 23b is arranged to be substantially coaxial with the gear 23a. Thus, when the gear 23a is driven to rotate by the gear 22b, the fastening part 23b rotates with the gear 23a.

The connection component 21 includes a connection sheet 21a. In the present embodiment, the connection sheet 21a is formed into an L-shaped sheet and is provided with an installation hole 21a1. In the drawings corresponding to the present embodiment, the connection sheet 21a is bent to approximately 90 degrees. However, it can be easily understood by those skilled in the art that the connection sheet 21a can also be formed to other shapes or bent to other angles according to the angle of the installation surface of the structural member and the setting position of the connection assembly, as long as it can make the connection sheet 21a face the installation surface of the corresponding structural member on one side and face the connection assembly on the other side. The installation hole 21a1 is used for the screw or other fixing components to pass through to fix the connection sheet 21a with the corresponding structural member. Alternatively, the installation hole 21a1 can be formed into a circle or a long strip shape. When formed into a long strip shape, the installation hole 21a1 can provide a certain adjustment margin for the fixation and installation of the connection component 21, so that the influence of manufacturing tolerance of the component or the deformation thereof due to the environment on the installation can be minimized.

In an alternative embodiment, the connection component 21 also includes a screw 21b that can be separated from the connection sheet 21a. The connection sheet 21a is provided with a hole 21a2 on the side facing the connection assembly and the screw is suitable for passing through the hole 21a2. The hole 21a2 is not threaded so that the screw can slide relative to the hole. The screw 21b includes a screw head (or nut) with a larger diameter and a screw rod connected with the screw head. Specifically, the screw rod can pass through the hole 21a2 while the larger screw head (or nut) can prevent the screw 21b completely passing through the hole 21a2. By adding a gasket between the screw and the connection sheet or by other ways, the friction between the screw and the connection sheet can be increased so that the relative rotation between the connection sheet and the screw is hard to occur. The screw rod of the screw is arranged to have a thread cooperates with the fastening part 23b, that is, the external thread of the screw 21b cooperates with the internal thread of the fastening part 23b.

All the screw rods and the fastening parts are threaded in the same direction.

Thus, when the fastening part 23b rotates with the gear 23a, the friction between the screw 21b and the connection sheet 21a causes the screw to be fixed or the screw head (or nut) of the screw is fixed manually, so that the internal thread of the fastening part 23b can rotate relative to the external thread of the screw rod. The threads convert a circumferential rotation force into an axial pulling force that pulls the screw closer to the base 24 or pushes it far apart from the base 24, and then pulls the connection sheet and the structural member connected with the connection sheet closer or loosens them up.

In another alternative embodiment, the screw 21b can be replaced by a screw rod 21b fixedly connected with the connection sheet 21. The screw rod 21b is fixedly connected (for example, by welding) to the side of the connection sheet 21a facing the connection assembly. Thus, when the fastening part 23b rotates with the gear 23a, the internal thread of the fastening part 23b can rotate relative to the external thread of the screw rob 21b2 as the screw rod 21b is fixed to the connection sheet 21a. The threads convert a circumferential rotation force into an axial pulling force to pull the screw rod closer to the base 24 or push it far apart from the base 24.

Thus, the adjustment component 22 is driven to rotate manually or by tools so that the bevel gear 22b of the adjustment component 22 drives the bevel gears 23a of the two follow-up components 23 to rotate in the same direction (clockwise or counterclockwise), and then the fastening part 23b is driven to rotate in the same direction. This then makes the screw rods on the two connection components which are fixed relative to the connection sheets to be pulled closer to the base 24 simultaneously, thus achieving the connection and fastening of the flat structural members 1a and 1b.

Further, driving the adjustment component 22 to rotate in the opposite direction can loosen the connection fastener, which can make the connection structure to be detached more conveniently.

Further, the structural members 1a and 1b can also be provided with a convex structure 11 and a groove structure 12 that cooperate with each other on the end surfaces to be connected, which thus can facilitate alignment and positioning of the structural members 1a and 1b and increase the tightness and accuracy of the connection.

In the present embodiment, the gear of the adjustment component arranged in the vertical direction drives the gears of the two follow-up components arranged opposite to each other in the horizontal direction to rotate so as to drive the cylinder-shaped fastening parts of the follow-up components with internal thread to rotate. The rotation in the first direction is converted into the rotation in the second direction by gear transmission. Then the circumferential rotation force applied by the gear to the fastening parts is converted into the axial force of the fastening parts through the threads, so that the two structure members with end surfaces opposite to each other can be tightened relative to each other.

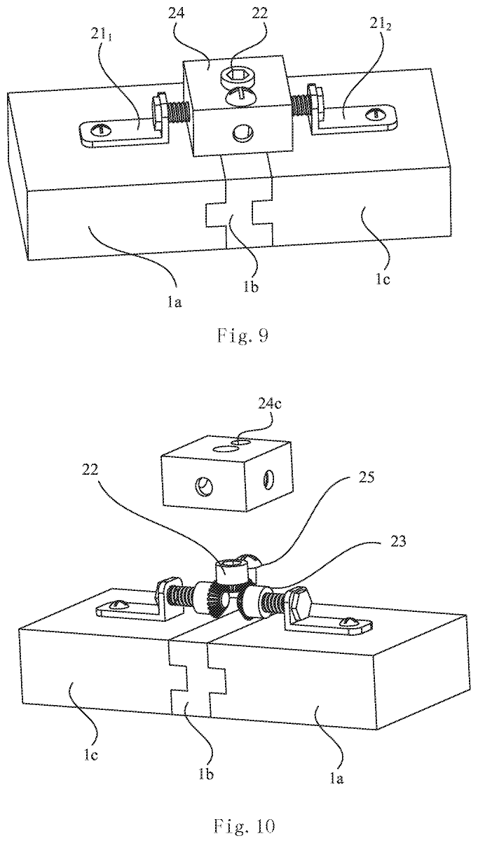

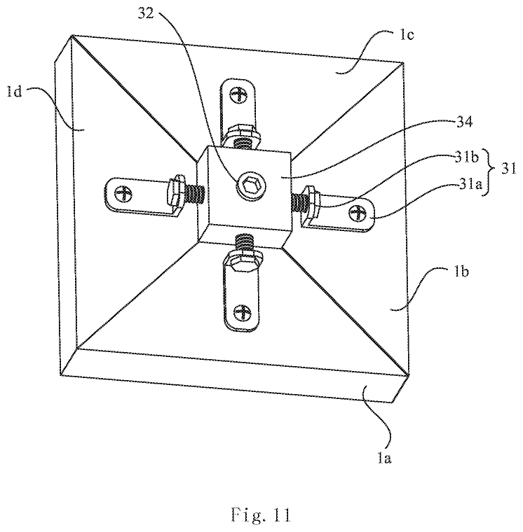

The connection structure and the connection fastener according to the second embodiment of the present disclosure are shown in FIGS. 9 and 10. In the present embodiment, the connection structure includes three sequentially arranged structural members 1a, 1b and 1c. The connection fastener according to the present embodiment is used for connecting and fastening the above three structural members. Among them, the connection fastener 2 includes a pair of connection components 21 fixedly connected to the structural members 1a and 1c respectively. The connection assembly of the connection fastener is fixedly connected with the structural member 1b. In a similar way to that as described in the first embodiment, the rotation of the adjustment component 22 can drive the follow-up components 23 to rotate, and then pull the screw rods of the connection components on both sides closer to the base 24, so that the structural members 1a, 1b and 1c are connected with each other. Specifically, the base 24 is provided with a fixed hole 24c and the base 24 and the structural member 1b can be fixed with each other by a screw 25 passing through the fixed hole 24c. Thus, three sequentially arranged structural members are connected and fastened with each other by one connection fastener. The arrangement of the adjustment component, the follow-up component and the connection sheet of the present embodiment is similar to that as described in the first embodiment, and will not be repeated here.

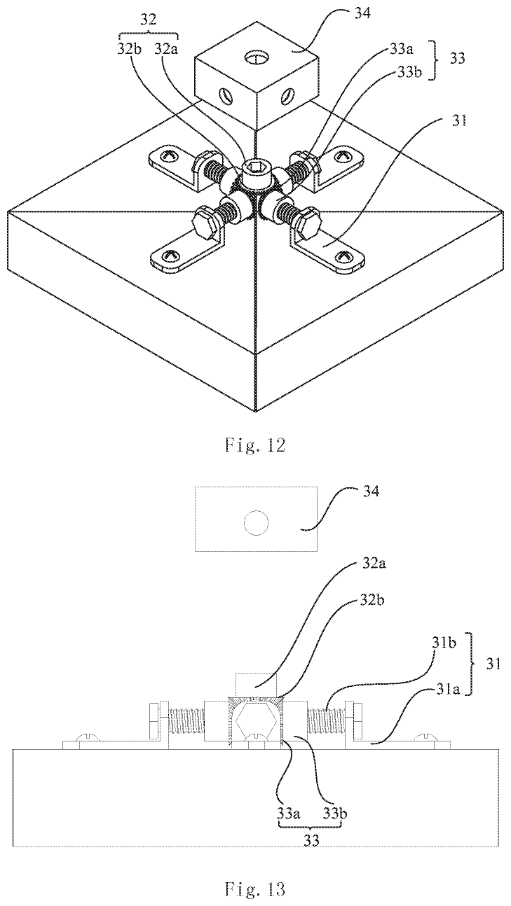

The connection structure and the connection fastener according to the third embodiment of the present disclosure are shown in FIGS. 11-13. In the present embodiment, the connection structure includes four structural members 1a, 1b, 1c and 1d that are connected together by the connection fastener 3. Specifically, the connection fastener 3 includes four connection components 31 and a connection assembly. The arrangement of the connection component 31 is the same as that described in the first and the second embodiments, including a connection sheet 31a and a screw 31b suitable to pass through the hole arranged on the connection sheet 31a. The four connection components 31 are respectively connected with the corresponding structural members 1a-1d and are connected with the connection assembly and tightened by the screws. The connection assembly includes an adjustment component 32, four follow-up components 33 and a base 34. Among them, the adjustment component 32 includes a main part 32a and a gear 32b and the axis of the adjustment component 32 is perpendicular to the installation plane. At the meanwhile, the follow-up component 33 includes a gear 33a and a fastening part 33b that is formed to a cylinder shape with a screw hole and coaxial with the gear 33a. The follow-up components 33 are arranged in two pairs in which two follow-up components are opposite to each other. The gears 33a of all the follow-up components 33 are connected with gear 32b of the adjustment component 32 and can be driven by the gear 32b to rotate in the same direction (clockwise or counterclockwise). Correspondingly, the fastening part 32b cooperates with the screw rod or the screw 31b to convert the circumferential rotation force into the axial force, thus pulling the screw rods or the screws 31b of the four connection components closer to the base 34 or pushing them far apart from the base simultaneously. Similar to the first and second embodiments, the screw rod or screw 31b is fixed relative to the connection sheet 31a so that the pulling force can be transmitted to the connection sheet, and then to the structural member so as to tighten and connect the four structural members 1a, 1b, 1c and 1d together.

It will be easily understood by those skilled in the art that the number of structural members that can be connected by the connection fastener of the present disclosure is not limited to two, three or four. For example, the connection fastener may be provided with only one follow-up component. In this case, the connection assembly is fixed with one structural member and the connection component is fixed with the other structural member, whereby the two structural members are connected together by using the fastening part of the follow-up component to connect the connection component and the connection assembly together. And for example, one of the follow-up components in the third embodiment can be removed and the connection fastener can still pull the three structural members closer to the base simultaneously and connect them together tightly. At the meanwhile, the follow-up components in the connection assembly can also be set to more than four. For example, the base is formed into a pentagon or a hexagon or a polygon with more sides with follow-up component arranged on each side correspondingly. Thus, multiple follow-up components can be driven to rotate by one adjustment component to pull the corresponding multiple structural members closer to the base to form a connection structure. The arrangement of the adjustment component, the follow-up component and the connection sheet of the present embodiment is similar to that of the first embodiment, and will not be repeated here.

At the meanwhile, the connection fastener of the present disclosure does not require the connection angle to be restricted.

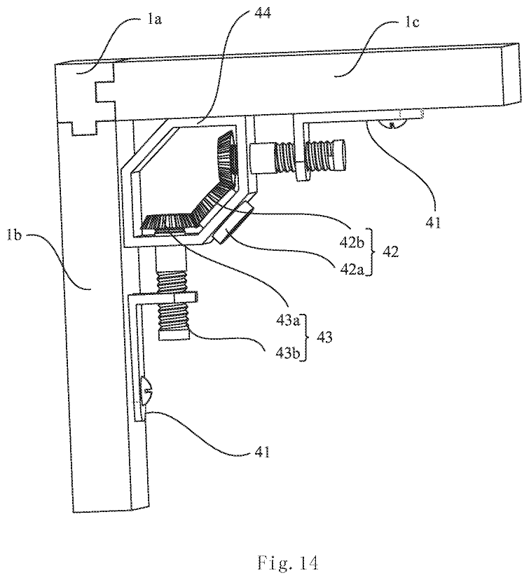

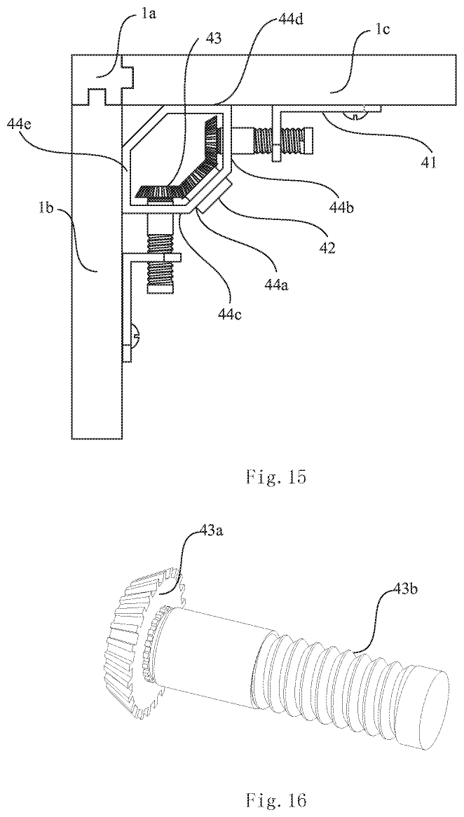

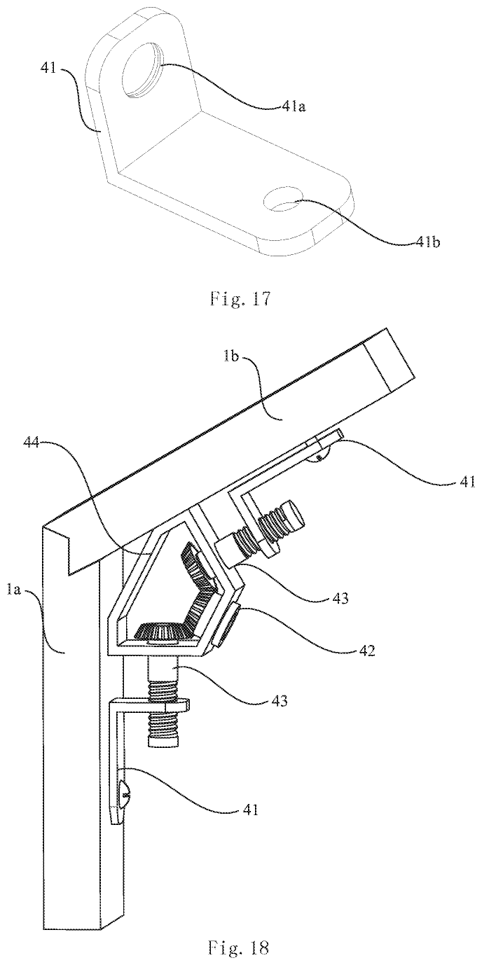

The connection structure and the connection fastener according to the fourth embodiment of the present disclosure are shown in FIGS. 14-17. In the present embodiment, the connection structure includes three structural members 1a, 1b and 1c. The structural member la can be an upright column or a beam while the structural members 1b and 1c are expected to be connected with the corresponding end faces of the structural member 1a in an approximately vertical manner. In one embodiment, the end faces of the structural members to be connected with each other can be provided with a convex structure and a groove structure that cooperate with each other so as to facilitate alignment thereof and further increase the connection tightness between the structural members.

The connection fastener 4 of the present embodiment includes two connection components 41 and a connection assembly. The connection component 41 is a connection sheet 41 provided with a screw hole 41a. Similar to the previous embodiments, the connection sheet 41 is formed into a L shape and provided with an installation hole 41b on the side facing the corresponding structural member. The installation hole 41b is used for the screw or other fixing components to pass through to fix the connection sheet 41 with the corresponding structural member. Alternatively, the installation hole 41b can be formed into a circle or a long strip shape. When formed into a long strip shape, the installation hole 41b can provide a certain adjustment margin for the fixation and installation of the connection sheet 41, so that the influence of manufacturing tolerance of the component or the deformation thereof due to the environment on the installation can be minimized. Unlike the previous embodiments, the connection sheet 41 of the present embodiment is provided with a screw hole 41a that cooperates with the screw rod of the follow-up component 43 of the connection assembly.

At the meanwhile, the connection assembly is arranged in a manner that it can be separated from the connection component 41 and includes an adjustment component 42, two follow-up components 43 and a base 44. The adjustment component 42 has a main part 42a and a gear 42b suitable for rotating with the main part. In the present embodiment, the gear 42b is formed as a bevel gear. Meanwhile, the main part 42a is formed to be substantially coaxial with the bevel gear with one end connected with the end face of the gear 42b. At the meanwhile, the main part 42a can be provided with a hexagonal slot on the side distant from the gear 42b for the inner hexagonal wrench to drive the main part 42a to rotate. Thus, when the main part 42a is driven to rotate, the gear 42b rotates as well.

The follow-up component 43 has a gear 43a and a fastening part 43b suitable for rotating with the gear 43a. The gear 43a is arranged to cooperate with the gear 42b. The follow-up component 43 and the adjustment component 42 are both rotatably fixed within the base 44 so that the gears 43a of all the follow-up components 43 are all connected with the gear 42b. The base 44 is provided with a hollow accommodation part to accommodate the gear 42b of the adjustment component and the gears 43a of the two follow-up components. In the present embodiment, the gear 43a is arranged as a bevel gear that cooperates with the gear 42b. Among them, the gear 42b is arranged in the way that the axis thereof points at the structural member 1a, while the axis of the gear 43a points at the connection surface and keeps parallel to the corresponding structural member. At the meanwhile, the gears 43a of the two follow-up components are arranged on both sides of the gear 42b. Thus, when the gear 42b rotates, the two gears 43a rotate in the same direction. By using this arrangement, the follow-up components, when driven by the adjustment component to rotate, can pull the connection components closer to the connection surface so as to achieve connection and fastening function. At the meanwhile, the end of the main part 42a of the adjustment component distant from the gear 42b is also distant from the connection surface so as to facilitate the adjustment thereof by the user.

At the meanwhile, the fastening part 43b of the follow-up component 43 is arranged as a screw rod with one end connected with the gear 43a. The thread of the screw rod and the thread of the screw hole 41a of the connection component cooperate with each other. The follow-up component 43 is fixed on the hole provided in the base 44 and cannot move along the axis, but can rotate. Thus, when the user rotates the main part 42a of the adjustment component 42, the gear 42b rotates therewith and drives the connected gear 43a to rotate, then drives the screw rod 43b, as the fastening part, to rotate relative to the screw hole 41a provided in the connection sheet 41. The threads that cooperate with each other convert the circumferential rotation force into the axial force so as to pull the connection sheet closer to the base 44 gradually.

Further, the base may be arranged to have sides suitable to fit to the surfaces of a plurality of structural members that are connected with each other so as to achieve the positioning of the base conveniently. As shown in the figures, the base 44 of the present embodiment is formed into a hexagon. Among them, the side 44a is provided with a hole through which the adjustment component can be exposed or protruded. The sides 44b and 44c adjacent to the side 44a are respectively provided with holes for fixing the follow-up components and allowing the follow-up components to protrude therethrough. The sides 44d and 44e are perpendicular to each other and are suitable for fitting to the structural members 1b and 1c so as to facilitate the positioning of base 44 during installation.

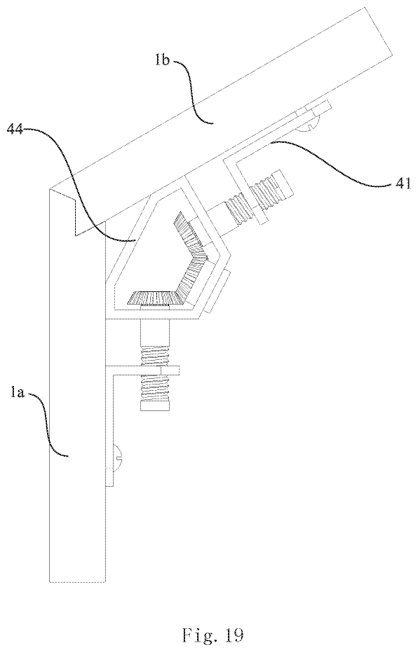

The connection structure and the connection fastener according to the fifth embodiment of the present disclosure are shown in FIGS. 18-19. In the present embodiment, the connection structure includes two structural members 1a and 1b. The structural members 1a and 1b are connected with each other at the ends where the structural members 1a and 1b are provided with a convex structure 11 and a groove structure 12 that cooperate with each other, which can facilitate the alignment and positioning of the structural members 1a and 1b and provide certain support function under specific circumstances. In the present embodiment, the structural elements 1a and 1b are connected to each other with an angle of 120 degrees formed therebetween. This is suitable for the connection of the sloping roof with the beam or side wall of the main body of the house in light buildings, for example. The structure of the connection fastener of the present embodiment is similar to that of the fourth embodiment, except that the angle between the axes of the two follow-up components of the connection assembly of the present embodiment is the same as the desired connection angle between the structural members. Thus, the connection fastener can exert a tighten force according to the desired connection angle of the structural members. In the embodiment as shown in FIG. 19, the base 44 is provided with sides fitting to the surfaces of the structural members 1a and 1b. The angle formed by the two sides is the same as the desired connection angle of the structural members 1a and 1b. Therefore, in the case that the two follow-up components are arranged to be parallel to the two sides respectively, the angle formed by the axes of the follow-up components can be made to be the same as the desired connection angle between the structural members.

At the meanwhile, the sides of the base fitting to the structural members can also transfer the stress or gravity to which one structural member is subjected to another structural member, so as to provide certain support function.

It should be understood that although the fastening part of the follow-up component is a cylindrical component provided with internal thread in the first to third embodiment for connecting flat structural members and the fastening part of the follow-up component is a screw rod in the fourth and fifth embodiments for connecting structural components with a connection angle of 90 degrees or 120 degrees, the above-mentioned fastening ways can be replaced with each other or combined. That is to say, the fastening part of the follow-up component of the first to the third embodiment may also be a screw rod, while the fastening part of the follow-up component of the fourth and fifth embodiments may also be a cylindrical component provided with internal thread. At the meanwhile, different forms of fastening parts can also be provided in the same connection fastener. For example, the fastening part of one of the follow-up components is arranged as a screw rod and the fastening part of another one of the follow-up components is arranged as a cylindrical component provided with internal thread. Of course, with respect to different forms of the fastening part, the connection component connected therewith should also be arranged in corresponding forms.

In summary, by arranging an adjustment component with a first gear and at least one follow-up component with a second gear, the rotation of the first gear of the adjustment component drives the second gear connected therewith to rotate, and then a fastening part of the follow-up component rotates with the second gear, and a circumferential rotation force applied to the fastening part by the gears is converted into an axial force of the fastening part through the threads, so as to tighten and fix two or more structural members at an arbitrary angle, thereby achieving a simple, fast and stable connection for multiple structural members.

The above description is just the preferred embodiments of the present disclosure, and it is not explained as any form limitation for the present disclosure. For those skilled in the art, various amendments or modifications may be made to the present disclosure. Any modification, equivalent substitution and improvement made in the spirit and principle of the present disclosure shall fall into the protection scope of the present disclosure.

What is claimed is:

1. A connection fastener for connecting a plurality of structural members, wherein the connection fastener comprising:
an adjustment component with a main part and a first gear suitable for rotating with the main part;
at least two follow-up components, wherein each of the at least two follow-up components has a second gear connected with the first gear and a fastening part suitable for rotating with the second gear, and the axis of the second gear is substantially parallel to the plane of the structural members that are connected;
a base provided with a hollow accommodation part to accommodate the first gear of the adjustment component and the second gears of all the follow-up components, wherein the base is also provided with multiple holes through which the fastening parts of the at least two follow-up components are exposed or protruded; and
connection components corresponding to the follow-up components one by one, each of the connection components connected with a respective fastening part of the follow-up component in a separable manner,
wherein the connection component has a connection sheet suitable for connecting with an installation surface of corresponding structural member and suitable for moving in axial direction of the fastening part with the rotation of the fastening part;
the at least two follow-up components are arranged so that the end faces of corresponding second gears are close to each other and the axes of the second gears are coplanar; and
the adjustment component is arranged so that the first gear is coupled with the second gears of the at least two follow-up components at the same time.

2. The connection fastener of claim 1, wherein the connection component further comprising:
a screw rod fixedly connected with the connection sheet in a non-relative rotation manner,
wherein the fastening part is formed into a cylindrical shape with a screw hole in the middle thereof, and the screw hole of the fastening part and the screw rod cooperate with each other.

3. The connection fastener of claim 1, wherein the connection sheet is provided with a hole, and
the connection component further comprising:
a screw suitable for protruding through the hole of the connection sheet,
wherein the fastening part is formed into a cylindrical shape with a screw hole in the middle thereof, and the screw hole of the fastening part and the screw cooperate with each other.

4. The connection fastener of claim 1, wherein the fastening part of the follow-up component is a screw rod with one end connected with the second gear, and
the connection sheet is provided with a screw hole arranged to cooperate with the screw rod.

5. The connection fastener of claim 1, wherein the follow-up component is rotatably arranged in the base.

6. The connection fastener of claim 1, wherein the first gear and the second gear are bevel gears that cooperate with each other.

7. The connection fastener of claim 6, wherein the connection fastener has two follow-up components, the end faces of the second gears of the two follow-up components are close to each other and the axes of the second gears form a predetermined included angle, and
the adjustment component is arranged in such a way that the first gear is positioned between the second gears of the two follow-up components.

8. The connection fastener of claim 7, wherein the predetermined included angle is the same as the included angle between the structural members to be connected and is greater than or equal to 90 degrees and less than or equal to 180 degrees.

9. The connection fastener of claim 1, wherein the base is provided with a fixed hole for fixing the base with corresponding structural member.

10. A connection assembly comprising:
an adjustment component with a main part and a first gear suitable for rotating with the main part;
at least two follow-up components, wherein each of the at least two follow-up components has a second gear connected with the first gear and a fastening part suitable for rotating with the second gear, and the axis of the second gear is substantially parallel to the plane of the structural members that are connected; and
a base provided with a hollow accommodation part to accommodate the first gear of the adjustment component and the second gears of all the follow-up components, wherein the base is also provided with multiple holes through which the fastening parts of the at least two follow-up components are exposed or protruded;
wherein the end faces of the second gears of the at least two follow-up components are close to each other and the axes of all the second gears are coplanar; and the adjustment component is arranged so that the first gear is coupled with the second gears of all the follow-up components at the same time.

11. The connection assembly of claim 10, wherein the fastening part is formed into a cylindrical shape with a screw hole in the middle thereof.

12. The connection assembly of claim 10, wherein the fastening part is a screw rod with one end connected with the second gear.

13. The connection assembly of claim 10, wherein the follow-up component is rotatably arranged in the base.

14. The connection assembly of claim 10, wherein the first gear and the second gear are bevel gears that cooperate with each other.

15. The connection assembly of claim 14, wherein the connection assembly has two follow-up components which are arranged so that the end faces of corresponding second gears are close to each other, and the axes of the second gears form a predetermined included angle, and
the adjustment component is arranged in such a way that the first gear is positioned between the second gears of the two follow-up components.

16. The connection assembly of claim 15, wherein the predetermined included angle is the same as the included angle between the structural members to be connected and is greater than or equal to 90 degrees and less than or equal to 180 degrees.

17. The connection assembly of claim 10, wherein the base is provided with a fixed hole for fixing the base with corresponding structural member.

18. A connection structure comprising:
a plurality of structural members; and
a connection fastener for connecting the plurality of structural members with each other,
wherein the connection fastener comprising:
an adjustment component with a main part and a first gear suitable for rotating with the main part;
at least two follow-up components, wherein each of the at least two follow-up components has a second gear connected with the first gear and a fastening part suitable for rotating with the second gear, and the axis of the second gear is substantially parallel to the plane of the structural members that are connected;
a base provided with a hollow accommodation part to accommodate the first gear of the adjustment component and the second gears of all the follow-up components, wherein the base is also provided with multiple holes through which the fastening parts of the at least two follow-up components are exposed or protruded; and
connection components corresponding to the follow-up components one by one, each of the connection components connected with a respective fastening part of the follow-up component in a separable manner,
wherein the connection component has a connection sheet suitable for connecting with an installation surface of corresponding structural member and suitable for moving in axial direction of the fastening part with the rotation of the fastening part;
the at least two follow-up components are arranged so that the end faces of corresponding second gears are close to each other and the axes of the second gears are coplanar; and
the adjustment component is arranged so that the first gear is coupled with the second gears of the at least two follow-up components at the same time.
